(19) United States
(12) Patent Application Publication
(10) Pub. No.: US 2026/0259311 A1
(43) Pub. Date: Sep. 3, 2026

(54) OBJECT DETECTION DEVICE AND OBJECT DETECTION METHOD

(71) Applicant: ASTEMO, LTD., Tokyo (JP)

(72) Inventors: Nobuyuki TAKAYA, Hitachinaka-shi, Ibaraki (JP); Hiroshi KURODA, Hitachinaka-shi, Ibaraki (JP); Taku TAKAHAMA, Hitachinaka-shi, Ibaraki (JP)

(73) Assignee: ASTEMO, LTD., Tokyo (JP)

(21) Appl. No.: 19/159,972

(22) PCT Filed: Feb. 28, 2023
(86) PCT No.: PCT/JP2023/007257

§ 371 Date: Aug. 26, 2025

(51) Int. Cl. G01S 13/56; G01S 13/931; G06V 20/58

(52) U.S. Cl. CPC G01S 13/56; G01S 13/931; G06V 20/58

(57) ABSTRACT

There are provided an object detection device and an object detection method capable of determining an object as a stationary object even in a situation where the object is determined as a moving object that reciprocates left and right due to an angle error, for example. For example, it is determined whether an object (detection target object) has moved in each of the clockwise and counterclockwise directions (rightward and leftward directions) in a circumferential direction, and the reliability is added or subtracted in each of the clockwise and counterclockwise directions (rightward and leftward directions). Then, it is determined whether the object (detection target object) is a moving object (including a moving direction) or a stationary object using the result of the added/subtracted reliability.

### TECHNICAL FIELD

The present invention relates to an object detection device and an object detection method capable of discriminating between a stationary object and a moving object even in a situation where angular accuracy deteriorates, for example.

### BACKGROUND ART

In recent years, vehicles are required to improve collision safety performance for pedestrians. In particular, since the agreement rules are applied as laws and regulations of each country, mounting is essential. Among the agreement rules, Regulation No. 159(UNR159 ) requires alarm output even when the host vehicle and an alarm target are stopped (both a ground speed and a relative speed are 0 km/h). Conventionally, erroneous detection and erroneous alarm have been suppressed by not recognizing a stationary object as an object (see (a) of FIG. 1), but detection of a stationary object has become essential in addition to the above-described laws and regulations. For example, the radar has high accuracy of the distance and speed in a line-of-sight direction, but cannot measure the speed in a circumferential direction, and the angular accuracy is worse than the distance accuracy. Therefore, in a case where a stationary object is set as a detection (alarm determination) target, it is not possible to distinguish an angular error from a moving object (crossing pedestrian), and the stationary object may be erroneously determined as a moving object (crossing object) (see (b) of FIG. 1). In particular, when a plurality of stationary objects are present at equal distances, angular accuracy tends to deteriorate due to fine positions of detection points and multipath.

PTL 1 is known as a conventional technique for determining whether an object having a speed of 0 m/s in a line-of-sight direction is a stationary object (wall) or a moving object.

In PTL 1, when a wall is erroneously determined as a moving object under a situation where the wall is present on a side surface during movement of a host vehicle, whether the wall is a wall or a parallel traveling object can be determined by comparing a movement history with a current detection point.

### CITATION LIST

### Patent Literature

PTL 1: JP 2022-133623 A

### SUMMARY OF INVENTION

### Technical Problem

However, PTL 1 is based on the premise that detection points are generated in addition to a target, and cannot be applied to a case where only one detection point is output for an object. Under a situation where a plurality of stationary objects are present at equal distances and only one detection point is detected, there is a concern that a large angular error occurs and it is determined that the stationary object is a moving object that reciprocates left and right.

The present invention has been made in view of the above problems, and an object of the present invention is to provide an object detection device and an object detection method capable of determining an object as a stationary object even in a situation where the object is determined as a moving object that reciprocates left and right due to, for example, an angle error.

### Solution to Problem

In order to solve the above problem, an object detection device according to the present invention includes a ground speed acquisition unit that acquires a relative position and a relative speed between a detection target object around a vehicle and the vehicle, the relative position and the relative speed being detected by an object recognition sensor mounted on the vehicle, and acquires a ground speed of the detection target object based on the relative position, the relative speed, a speed of the vehicle, and a yaw rate of the vehicle, and a determination unit that acquires, based on the ground speed, first-direction reliability that is an index indicating movement of the detection target object with respect to a predetermined first direction, acquires, based on the ground speed, second-direction reliability that is an index indicating movement of the detection target object with respect to a second direction that is a direction opposite to the first direction, and determines whether the detection target object is a stationary object or a moving object based on the first-direction reliability and the second-direction reliability.

Further, an object detection method according to the present invention is executed by a control unit mounted on a vehicle, and the object detection method includes, by the control unit, acquiring a relative position and a relative speed between a detection target object around a vehicle and the vehicle, the relative position and the relative speed being detected by an object recognition sensor mounted on the vehicle, acquiring a ground speed of the detection target object based on the relative position, the relative speed, a speed of the vehicle, and a yaw rate of the vehicle, acquiring, based on the ground speed, first-direction reliability that is an index indicating movement of the detection target object with respect to a predetermined first direction, acquiring, based on the ground speed, second-direction reliability that is an index indicating movement of the detection target object with respect to a second direction that is a direction opposite to the first direction, and determining whether the detection target object is a stationary object or a moving object based on the first-direction reliability and the second-direction reliability.

### Advantageous Effects of Invention

According to the present invention, for example, even in a situation where an object is determined as a moving object that reciprocates left and right due to an angle error, the object can be determined as a stationary object.

Problems, configurations, and effects other than those described above will be clarified by the following description of embodiments.

### BRIEF DESCRIPTION OF DRAWINGS

FIG. 1 is an explanatory diagram of a conventional concept with respect to a stationary object and a problem in a case of being set as a detection (alarm determination) target.

FIG. 2 is a system configuration example of an object detection device in a first embodiment.

FIG. 3 is a calculation image diagram of a line-of-sight direction ground speed and a circumferential direction ground speed.

FIG. 4 is a flowchart of a line-of-sight direction movement determination unit 13 in the first embodiment.

FIG. 5 is a flowchart of a circumferential direction movement determination unit 14 in the first embodiment.

FIG. 6 is a truth table of determinations of a stationary object and a moving direction using moving-direction reliability.

FIG. 7 is an explanatory diagram of a simulation environment of the first embodiment.

FIG. 8 illustrates parameters used for simulation (conventional method).

FIG. 9 illustrates parameters used for simulation (the first embodiment).

FIG. 10 is an explanatory diagram of a result of the simulation.

FIG. 11 is an explanatory diagram of a concept of an error by a monocular camera in a second embodiment.

FIG. 12 is a flowchart of a circumferential direction movement determination unit 14 in the second embodiment.

FIG. 13 is a flowchart of a line-of-sight direction movement determination unit 13 in the second embodiment.

FIG. 14 is an explanatory diagram of factors that are not applied at time of high-speed traveling in a third embodiment.

### DESCRIPTION OF EMBODIMENTS

Hereinafter, embodiments of the present invention will be described with reference to the drawings.

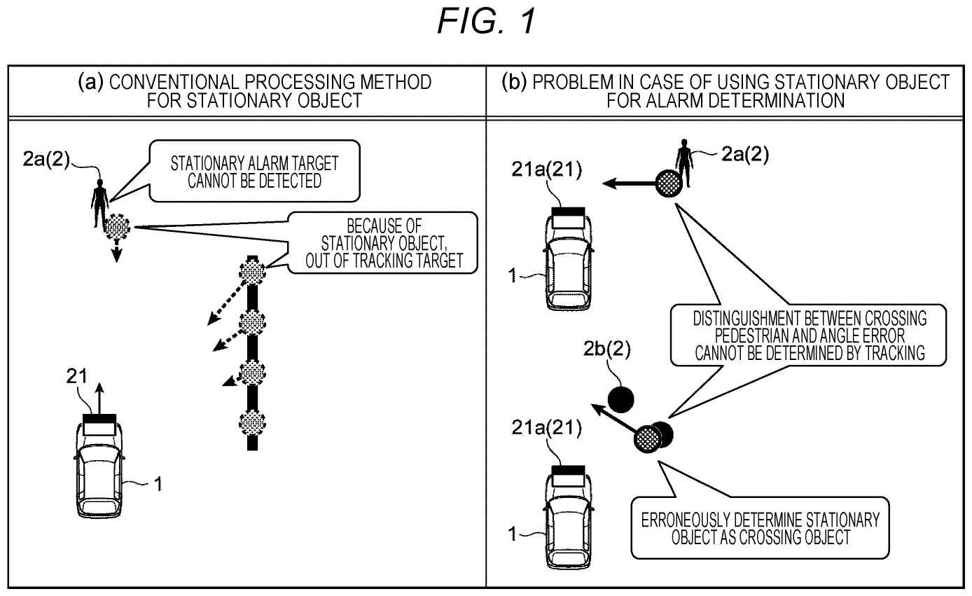

Conventionally, as illustrated in (a) of FIG. 1, when an object recognition sensor 21 mounted on a vehicle (host vehicle) 1 recognizes (detects) an object 2 present around the vehicle 1, a stationary object is not recognized as an object, thereby suppressing erroneous detection and erroneous alarm. Therefore, it is not possible to detect a moving object (crossing pedestrian or the like) 2a which is a stationary alarm target. For example, a radar 21a as the object recognition sensor 21 is in a state where the angular accuracy is worse than the distance accuracy. Therefore, in a case where a stationary object is detected (alarm determination) using the radar 21a as the object recognition sensor 21, as illustrated in (b) of FIG. 1, it is not possible to distinguish between a moving object (crossing pedestrian or the like) 2a and an angular error, and a stationary object (electric poles, signs, or the like) 2b may be erroneously determined as a moving object (crossing object). In order to cope with such a problem, the present invention applies embodiments described below.

### First Embodiment

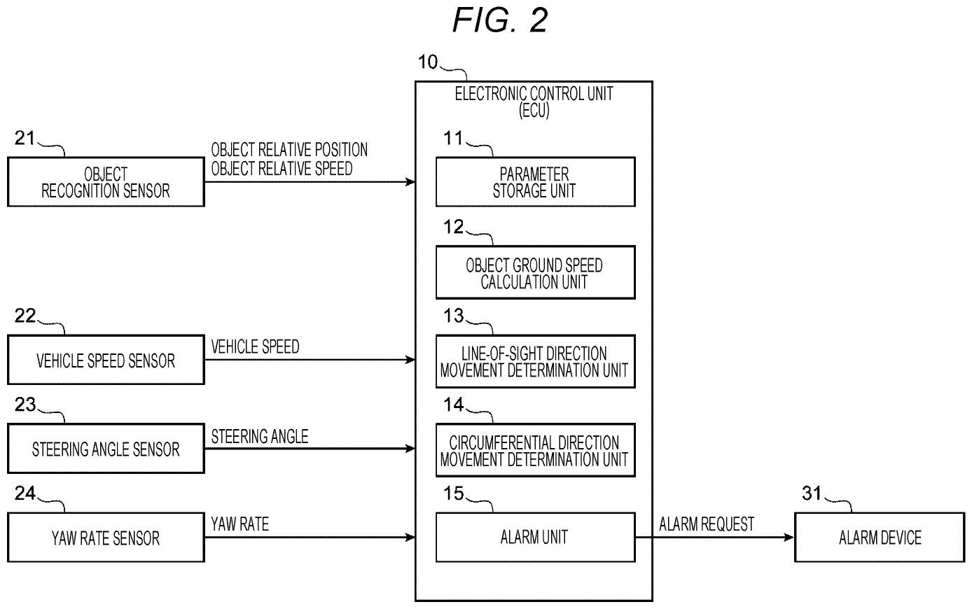

Hereinafter, a vehicle control device 10 which is an object detection device according to the first embodiment of the present invention will be described with reference to FIGS. 2 to 10.

FIG. 2 is a functional block diagram of a driving assistance system mounted on the host vehicle 1 of the present embodiment. This driving assistance system is a system in which an object recognition sensor 21, a vehicle speed sensor 22, a steering angle sensor 23, and a yaw rate sensor 24 are provided on an input side of the vehicle control device 10, and an alarm device 31 is provided on an output side. Note that it is assumed that they are communicably connected by a CAN (controller area network) or the like.

The object recognition sensor 21 is a sensor that acquires information regarding an object 2 (for example, a moving object 2a such as another vehicle or a pedestrian) around the host vehicle 1, and is, for example, a radar 21a, a monocular camera 21b, or the like. When the object recognition sensor 21 is the monocular camera 21b, it is possible to sequentially measure the relative position PTR (X_{TR}/Y_{TR}) of the object 2 from each piece of photographing data and calculate the relative speed V_{IR} of the object 2 from the displacement of the object 2 in each piece of photographing data. In addition, when the object recognition sensor 21 is the radar 21a or the like, it is possible to directly measure the relative position and the relative speed of the object 2.

Note that, in the present the first embodiment, control contents in a case where the object recognition sensor 21 is the radar 21a will be described.

The vehicle speed sensor 22 is a sensor that detects a host vehicle speed Vₛ, and calculates the host vehicle speed Vₛ on the premise that the host vehicle 1 is traveling straight, based on a rotation speed of a tire output from a wheel speed sensor, for example.

The steering angle sensor 23 is a sensor that acquires a steering angle (amount) of the host vehicle 1, and is, for example, an angle sensor mounted on the steering.

The yaw rate sensor 24 is a sensor that acquires a yaw rate ω of the host vehicle 1, and is, for example, an acceleration sensor that detects an acceleration around an up-down direction axis of the host vehicle 1. Since the yaw rate ω can be calculated by the vehicle speed sensor 22 and the steering angle sensor 23, the yaw rate sensor 24 may be omitted.

The alarm device 31 is a device that, in a case where the vehicle control device 10 outputs an alarm request, gives a driver an alarm of a possibility of collision with the object 2 via display indication, LED light emission, steering operation, sound notification, or the like, and urges the driver to perform an appropriate avoidance operation. Note that, in FIG. 2, the driver is urged to perform the avoidance operation with the alarm device 31. In a case where there is a possibility of collision, the vehicle control device 10 may function as a system that directly controls braking or steering of the host vehicle 1.

### <Vehicle Control Device 10>

Next, a system configuration of the vehicle control device 10 of the present embodiment will be described. As illustrated in FIG. 2, the vehicle control device 10 that is an object detection device includes a parameter storage unit 11, an object ground speed calculation unit 12, a line-of-sight direction movement determination unit 13, a circumferential direction movement determination unit 14, and an alarm unit 15. Then, processing by the object ground speed calculation unit 12, the line-of-sight direction movement determination unit 13, the circumferential direction movement determination unit 14, and the alarm unit 15 is periodically executed, and, in a case where a predetermined condition is satisfied, an alarm request is created and output to the alarm device 31. Note that the vehicle control device 10 is specifically an ECU (Electronic Control Unit) including an arithmetic device such as a CPU, a storage device such as a semiconductor memory, and hardware such as a communication device. Then, the arithmetic device executes a program loaded in the storage device to implement each function of the line-of-sight direction movement determination unit 13 or the like, and description will be made below while such a well-known technique is appropriately omitted.

The parameter storage unit 11 is a storage device that stores vehicle parameters and alarm parameters. The vehicle parameter is a parameter mainly used by the circumferential direction movement determination unit 14, and is, for example, a parameter related to specifications of the host vehicle 1 such as a movement threshold value and a reliability threshold value in the circumferential direction, a wheelbase, or a gear ratio for converting a steering angle into a tire angle. In addition, the alarm parameter is a parameter mainly used by the alarm unit 15, and is a parameter such as a TTC threshold value for comparison with a collision grace time (Time To Collision, referred to as “TTC” below) of an alarm candidate.

The object ground speed calculation unit 12 can obtain the ground speed from the vehicle speed of the vehicle 1 and the object relative speed of the object recognition sensor 21. However, a method of calculating the ground speed is not particularly limited, and a known ground speed calculation method can be used. Furthermore, the relative speed may be calculated using the object relative position of the object recognition sensor 21, and the ground speed may be calculated together with the above-described vehicle information (the vehicle speed and the yaw rate of the vehicle 1).

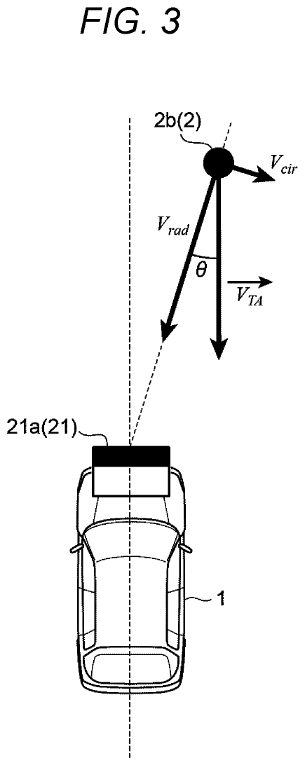

As illustrated in FIG. 3, the line-of-sight direction movement determination unit 13 is processing of calculating the ground speed in the line-of-sight direction of the object recognition sensor 21 using V_{rad}=V_{TA}cosθ, from the object ground speed V_{TA} calculated by the object ground speed calculation unit 12, and determining whether the object is a stationary object or a moving object using the ground speed in the line-of-sight direction of the object recognition sensor 21. The line-of-sight direction movement determination unit 13 may be implemented together with the circumferential direction movement determination unit 14. In the first embodiment, processing of the line-of-sight direction movement determination unit using the radar 21a will be described. In a second embodiment described later, processing of the line-of-sight direction movement determination unit using the monocular camera 21b will be described. In addition, in a third embodiment, the reason for using the conventional stationary: object determination result at the time of high-speed traveling will be described.

As illustrated in FIG. 3, the circumferential direction movement determination unit 14 is processing of calculating the ground speed in the circumferential direction of the object recognition sensor 21 using V_{cir}=V_{TA}sinθ, from the object ground speed V_{TA} calculated by the object ground speed calculation unit 12, and determining whether the object is a stationary object or a moving object using the ground speed in the circumferential direction of the object recognition sensor 21. In the first embodiment, processing of the circumferential direction movement determination unit using the radar 21a will be described. In the second embodiment described later, processing of the circumferential direction movement determination unit using the monocular camera 21b will be described. In addition, in the third embodiment, the reason for using the conventional stationary object determination result at the time of high-speed traveling will be described.

The alarm unit 15 calculates the possibility of collision with the object 2 and the TTC using the object recognition sensor 21, the vehicle speed sensor 22, the steering angle sensor 23, the yaw rate sensor 24, the parameter storage unit 11, the object ground speed calculation unit 12, the line-of-sight direction movement determination unit 13, and the circumferential direction movement determination unit 14, and outputs an alarm request for calling the attention of the driver. The alarm unit 15 may output an alarm using the alarm device 31, or the ECU itself may output an alarm. Further, the alarm unit 15 may not only be the alarm but also be a unit that controls a vehicle, such as a brake or a steering.

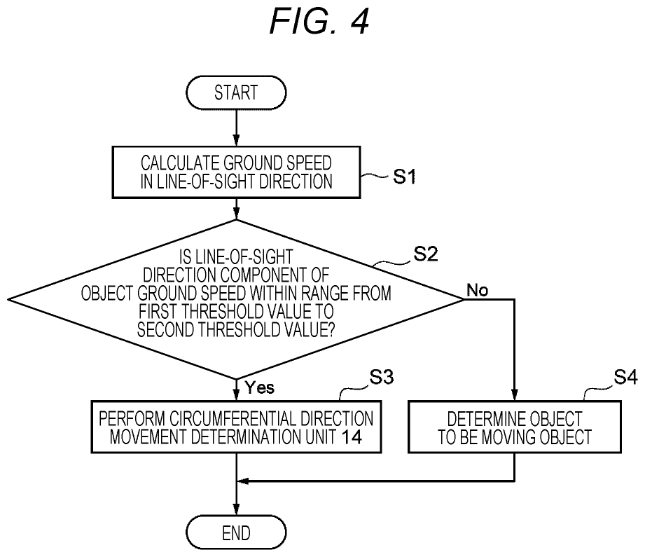

Next, the line-of-sight direction movement determination unit 13 will be described with reference to the flowchart of FIG. 4.

### Step S1:

First, the line-of-sight direction movement determination unit 13 calculates a line-of-sight direction component V_{rad} of the object ground speed using V_{rad}=V_{TA}cosθ, from the object ground speed V_{TA} Calculated by the object ground speed calculation unit 12 as illustrated in FIG. 3.

### Step S2:

Then, it is determined whether the object is a stationary object or a moving object by using the line-of-sight direction component V_{rad} of the object ground speed calculated in Step S1. That is, it is determined whether or not the line-of-sight direction component V_{rad} of the object ground speed is within a range from a first threshold value to a second threshold value. When the line-of-sight direction component V_{rad} of the object ground speed is within the range from the first threshold value to the second threshold value, it can be determined that the object is not moving in the line-of-sight direction. It is determined that the line-of-sight direction component corresponds to a stationary object, and Step S3 is executed. When the line-of-sight direction component V_{rad} of the object ground speed is out of the range from the first threshold value to the second threshold value, the line-of-sight direction component is determined to be moving, and Step S4 is executed.

### Step S3:

Since it is determined in Step S2 that the line-of-sight direction component corresponds to a stationary object, if the object is also a stationary object in the circumferential direction, it can be determined that the object is a stationary object. Therefore, the circumferential direction movement determination unit 14 is performed to determine whether the object is a stationary object or a moving object.

### Step S4:

It is determined in Step S3 that the line-of-sight direction component corresponds to a moving object. Since the line-of-sight speed component of the radar 21a is a result of direct measurement, the circumferential direction movement determination unit 14 is not performed, and the object is determined to be a moving object.

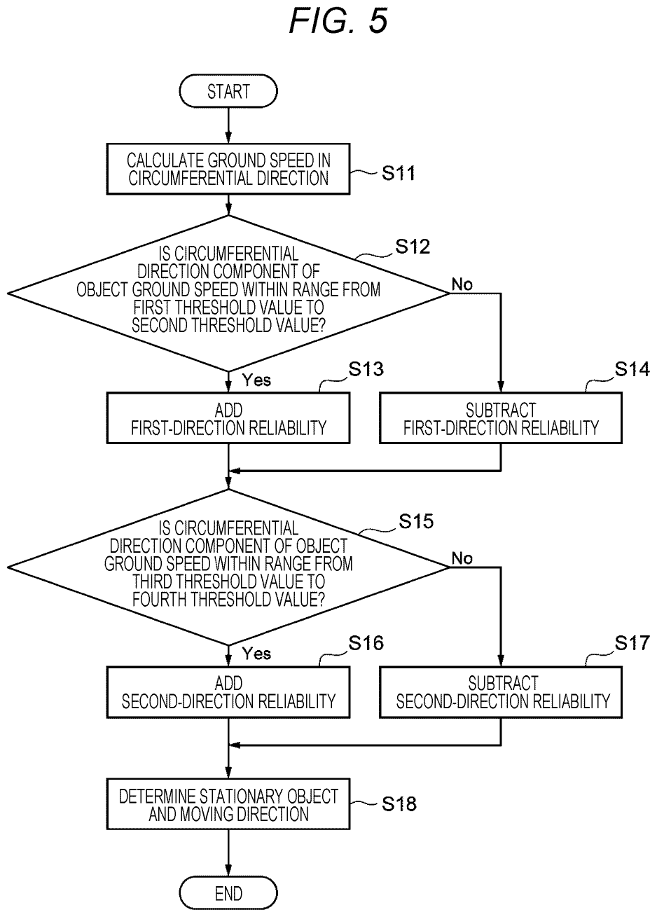

Next, the circumferential direction movement determination unit 14 will be described with reference to the flowchart of FIG. 5.

### Step S11:

First, the line-of-sight direction movement determination unit 13 calculates a circumferential direction component V_{cir} of the object ground speed from the object ground speed V_{TA} calculated by the object ground speed calculation unit 12 using V_{cir}-V_{TA}sinθ as illustrated in FIG. 3.

### Step S12:

Then, by using the circumferential direction component V_{cir} of the object ground speed calculated in Step S11, it is determined whether the object is moving in a first (counterclockwise or leftward) direction of the circumferential direction component. That is, it is determined whether or not the circumferential direction component V_{cir} of the object ground speed is within the range from the first threshold value to the second threshold value (within a range of movement in the first direction). When the circumferential direction component V_{cir} of the object ground speed is within the range of movement in the first direction, Step S13 is executed to add the reliability in the first direction. When the circumferential direction component V_{cir} of the object ground speed is out of the range of movement in the first direction, it is determined that the object is a stationary object, and Step S14 is executed to subtract the reliability in the first direction. For addition/subtraction of the first-direction reliability which is an index indicating the movement of the object with respect to the first direction, a plurality of reliability threshold values and addition/subtraction values of the reliability may be used using a table or the like.

### Step S13:

Based on the determination result of Step S12, it is determined that the object is a moving object in the first (counterclockwise or leftward) direction, and the first-direction reliability is added.

### Step S14:

Based on the determination result of Step S12, it is determined that the object is a stationary object, and the first-direction reliability is subtracted.

### Step S15:

Then, by using the circumferential direction component V_{cir} of the object ground speed calculated in Step S11, it is determined whether the object is moving in a second (clockwise or rightward) direction of the circumferential direction component. That is, it is determined whether or not the circumferential direction component V_{cir} of the object ground speed is within a range from a third threshold value to a fourth threshold value (within a range of movement in the second direction). When the circumferential direction component V_{cir} of the object ground speed is within the range of movement in the second direction, Step S16 is executed to add the reliability in the second direction. When the circumferential direction component V_{cir} of the object ground speed is out of the range of movement in the second direction, it is determined that the object is a stationary object, and Step S17 is executed to subtract the reliability in the second direction. For addition/subtraction of the second-direction reliability which is an index indicating the movement of the object with respect to the second direction that is a direction opposite to the first direction, a plurality of reliability threshold values and addition/subtraction values of the reliability may be used using a table or the like.

### Step S16:

Based on the determination result of Step S15, it is determined that the object is a moving object in the second (clockwise or rightward) direction, and the second-direction reliability is added.

### Step S17:

Based on the determination result of Step S15, it is determined that the object is a stationary object, and the second-direction reliability is subtracted.

### Step S18:

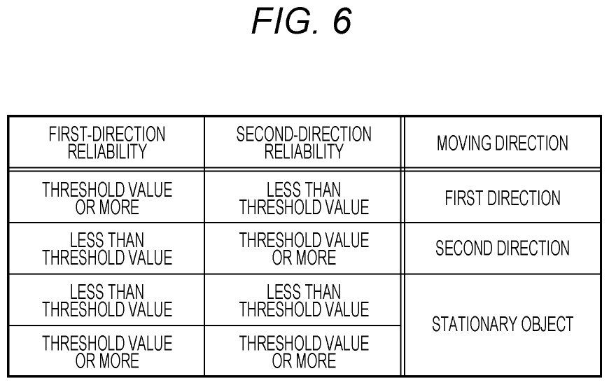

The first-direction reliability and the second-direction reliability acquired by performing addition and subtraction in Steps S13 and S14 based on Step S12 and in Steps S16 and S17 based on Step S15 are determined as a stationary object and a moving direction based on the truth table of FIG. 6. When only the first-direction reliability is the threshold value or more (the second-direction reliability is less than the threshold value), it is determined that the object moves in the first direction (in other words, the moving direction of the moving object is the first direction). When only the second-direction reliability is the threshold value or more (the first-direction reliability is less than the threshold value), it is determined that the object moves in the second direction (in other words, the moving direction of the moving object is the second direction). When both the first-direction reliability and the second-direction reliability are less than the threshold value, the object is determined to be a stationary object because the object is not moving. When both the first-direction reliability and the second-direction reliability are the threshold value or more, it is determined that the object is a diverging object and is determined as a stationary object.

that the threshold value for the first-direction reliability and the threshold value for the second-direction reliability may be the same value or different values.

### <Simulation Results>

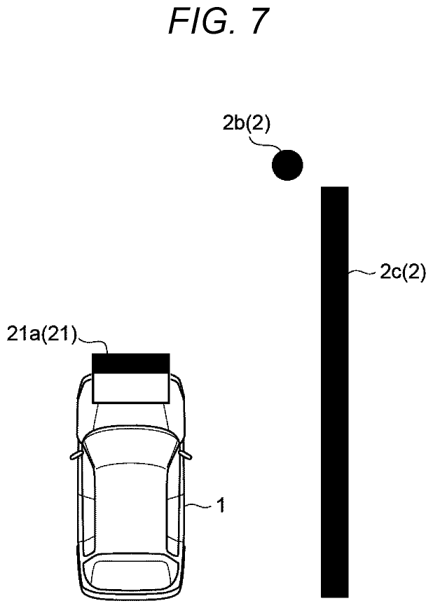

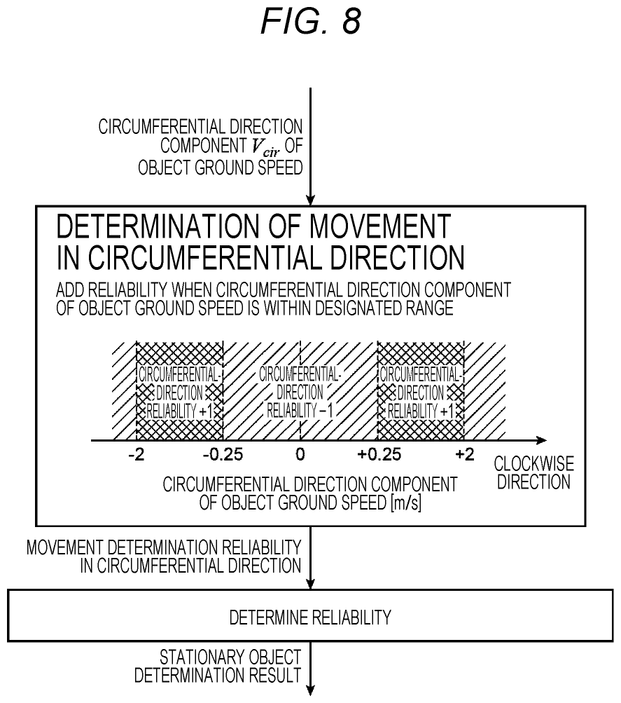

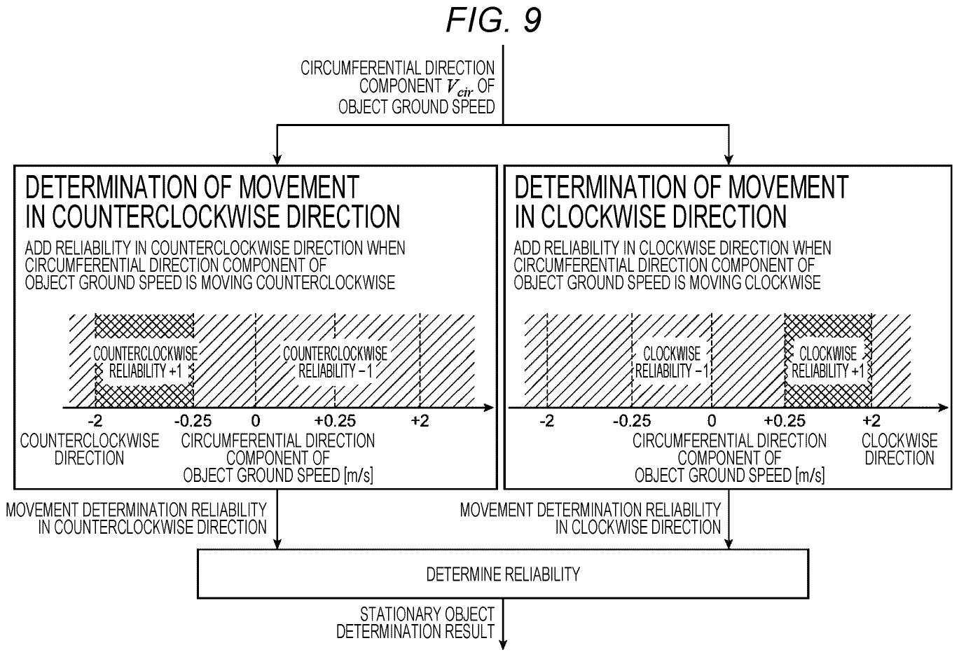

Results of applying the present embodiment to a situation when the problem has occurred will be described. As a scenario, as illustrated in FIG. 7, there is a stationary object (structural object) 2b having the same detection point as a stationary object (wall or the like) 2c, and both the host vehicle 1 and the object 2 are in a stationary state. A result obtained by applying the parameter of FIG. 8, which is the conventional method, to the measurement data (the circumferential direction component V_{cir} of the object ground speed) was compared with a result obtained by applying the parameter of FIG. 9 set in the first embodiment.

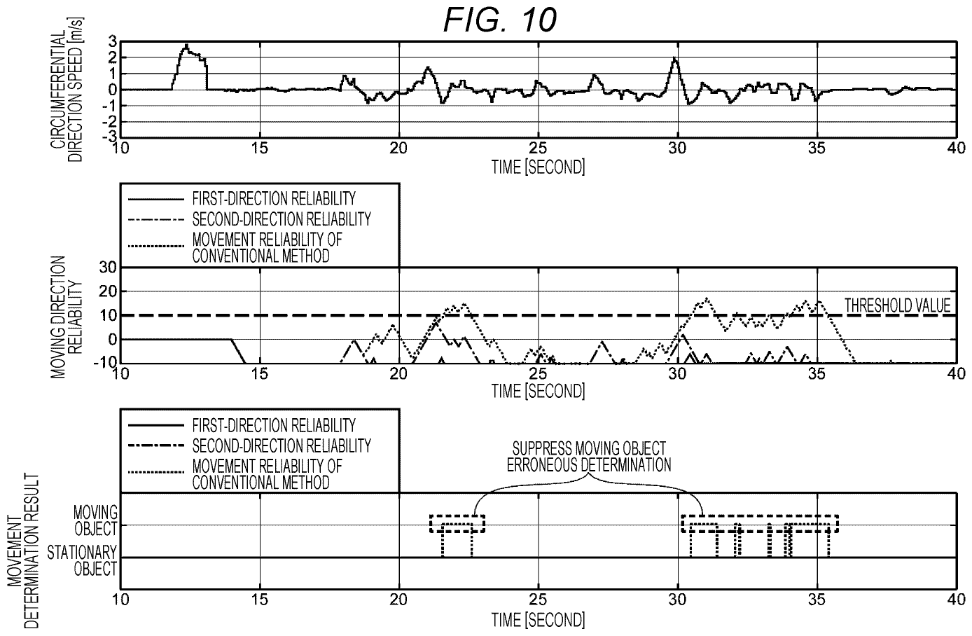

The application result is as illustrated in FIG. 10, and in the conventional method, the reliability exceeds the threshold value, and a stationary object is erroneously determined as a moving object. On the other hand, as a result of applying the setting of the first embodiment, the reliability is less than the threshold value, and the object is detected as a stationary object.

Therefore, by using the present embodiment, a stationary object is recognized as a stationary object without being erroneously determined as a moving object, and it is possible to improve the separation accuracy between a moving object and a stationary object. As a result, it is possible to determine the possibility of collision for an appropriate object, and an alarm or control can be performed.

### Second Embodiment

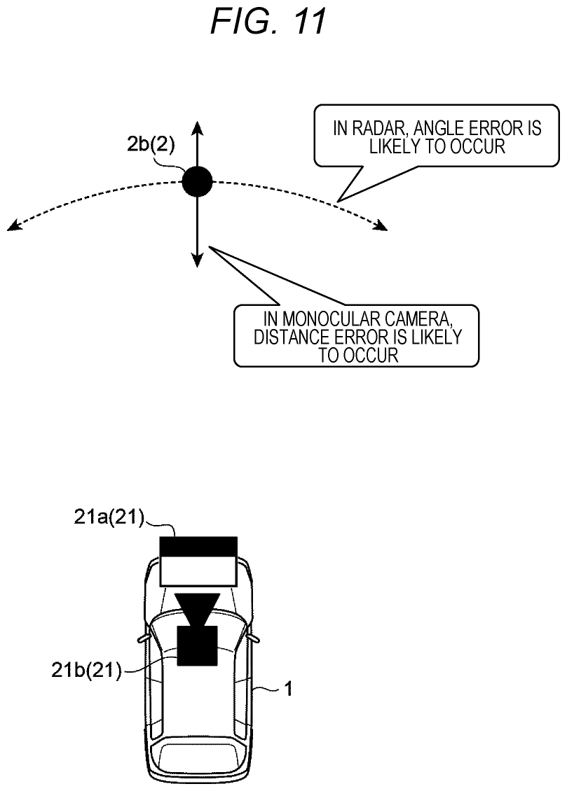

Next, a vehicle control device 10 which is an object detection device according to the second embodiment of the present invention will be described with reference to FIGS. 11 to 13. In the second embodiment, a difference when the object recognition sensor 21 used in the first embodiment is changed from the radar 21a to the monocular camera 21b will be described.

As illustrated in FIG. 11, the radar 21a has high accuracy in the line-of-sight direction and poor r accuracy in the circumferential direction (an angular error is likely to occur). On the other hand, the monocular camera 21b has poor accuracy in the line-of-sight direction (a distance error is likely to occur) and high accuracy in the circumferential direction. Therefore, the present embodiment is applied to the line-of-sight direction in which the accuracy may deteriorate.

Therefore, in the vehicle control device 10, the order of the processing performed by the object ground speed calculation unit 12, the line-of-sight direction movement determination unit 13, and the circumferential direction movement determination unit 14 in the first embodiment is performed in the order of the object ground speed calculation unit 12, the circumferential direction movement determination unit 14, and the line-of-sight direction movement determination unit 13 in the second embodiment.

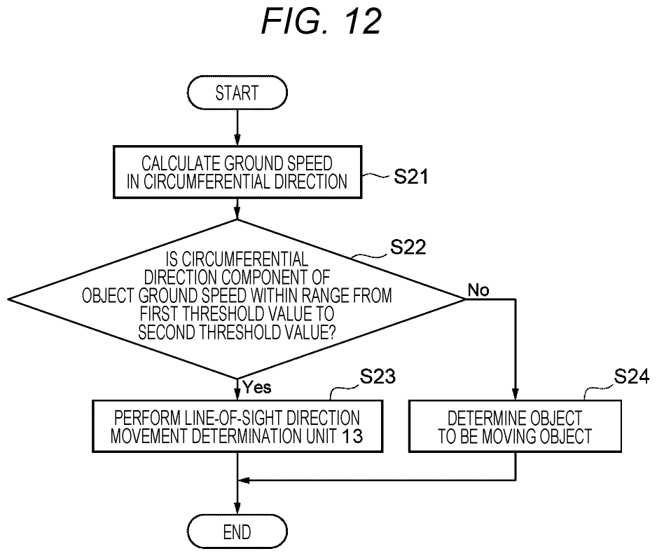

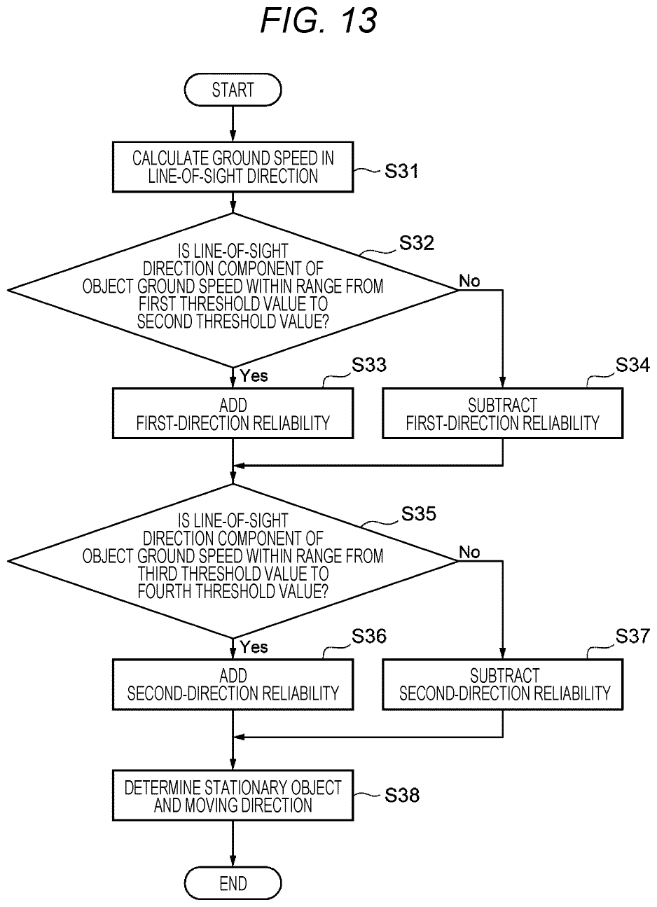

In addition, as illustrated in FIG. 12, the circumferential direction movement determination unit 14 uses a configuration in which the line-of-sight direction movement determination unit 13 of the first embodiment is applied in the circumferential direction. In addition, as illustrated in FIG. 13, the line-of-sight direction movement determination unit 13 uses a configuration in which the circumferential direction movement determination unit 14 of the first embodiment is applied in the line-of-sight direction. By performing the processing of FIG. 13, the line-of-sight direction movement determination unit 13 may determine an object to be an object that moves in the first (approaching) direction in the line-of-sight direction (in other words, the moving direction of a moving object is the first (approaching) direction), an object that moves in the second (separating) direction of the line-of-sight direction (in other words, the moving direction of the moving object is the second (separating) direction), or a stationary object.

Therefore, even in the present embodiment, a stationary object is recognized as a stationary object without being erroneously determined as a moving object, and it is possible to improve the separation accuracy between a moving object and a stationary object. As a result, it is possible to determine the possibility of collision for an appropriate object, and an alarm or control can be performed.

### Third Embodiment

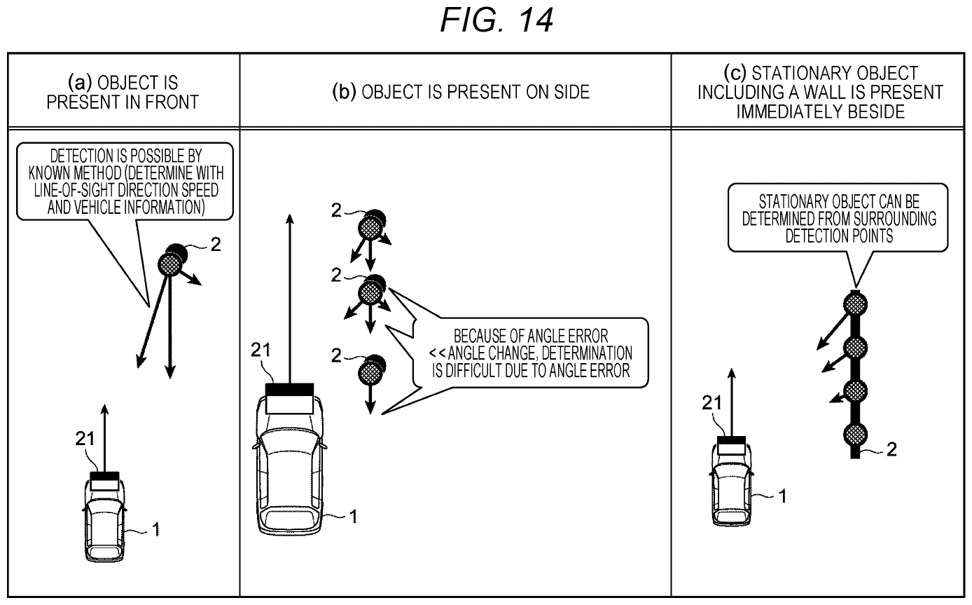

Next, the third embodiment of the present invention will be described with reference to FIG. 14. In the third embodiment, the reason why the circumferential direction movement determination unit 14 that is the determination unit of the first embodiment (alternatively, the line-of-sight direction movement determination unit 13 that is the determination unit of the second embodiment) is performed only at a low speed (a vehicle speed is a predetermined value or less) or at time of stop will be described.

In a case where the host vehicle 1 is moving forward at a high speed, as illustrated in FIG. 14, the examination when the object 2 is present in front of the host vehicle 1, when the object 2 is present on the side of the host vehicle 1, and when a detection target is an object 2 that is vertically long, such as a wall, has been performed.

As illustrated in (a) of FIG. 14, in a case where the object 2 is sufficiently far and present in front of the host vehicle 1, it is possible to determine the object to be a stationary object by a known method using the line-of-sight direction speed, and thus, it is determined that application is unnecessary.

As illustrated in (b) of FIG. 14, in a case where the object 2 is present on the side of the host vehicle 1, the angle change at the time of passing through the side is sufficiently larger than the angle error which is the problem of the present invention. Therefore, the effectiveness of the present invention was determined to be difficult to confirm.

In a case where a stationary object including a wall is present immediately beside as in (c) of FIG. 14, a known method of determining a wall including PTL 1 can be applied. Since stationary object determination is possible from a surrounding detection point, it is determined that application is unnecessary.

As the vehicle speed decreases, the influence of an angle error due to noise or a plurality of stationary objects increases. In addition, in a case where the vehicle speed is sufficiently large, the displacement is affected by the position change rather than the angle change. Therefore, the present embodiment is limited when the speed of the vehicle 1 is a predetermined value or less, particularly, when the vehicle 1 is stopped, and the processing time can be effectively reduced by determining whether the object (detection target object) is a stationary object or a moving object only when the difference in the line-of-sight speed of the stationary object due to the angle is small, and not performing the determination when the influence of the position change is large.

### Summary of First to Third Embodiments

As described above, the object detection device (vehicle control device 10) of the present embodiment includes:
the ground speed acquisition unit (object ground speed calculation unit 12) that
   acquires the relative position and the relative speed between a detection target object around a vehicle and the vehicle, the relative position and the relative speed being detected by the object recognition sensor 21 (radar 21a or monocular camera 21b) mounted on the vehicle, and
   acquires a ground speed of the detection target based on the relative position, the relative speed, a speed of the vehicle, and a yaw rate of the vehicle; and
the determination unit (circumferential direction movement determination unit 14 or line-of-sight direction movement determination unit 13) that
   acquires first-direction reliability that is an index indicating movement of the detection target object in the predetermined first direction (leftward direction in the circumferential direction around the object recognition sensor 21 or approaching direction in the line-of-sight direction of the object recognition sensor 21),
   acquires, based on the ground speed, second-direction reliability that is an index indicating movement of the detection target object in the second direction (rightward direction in the circumferential direction around the object recognition sensor 21 or separating direction in the line-of-sight direction of the object recognition sensor 21) that is a direction opposite to the first direction, and
   determines whether the detection target object is a stationary object or a moving object based on the first-direction reliability and the second-direction reliability.

Further, the object detection method of the present embodiment is an object detection method executed by a control unit (vehicle control device 10) mounted on the vehicle, and includes:
by the control unit,
acquiring the relative position and the relative speed between a detection target object around a vehicle and the vehicle, the relative position and the relative speed being detected by the object recognition sensor 21 (radar 21a or monocular camera 21b) mounted on the vehicle;
acquiring a ground speed of the detection target based on the relative position, the relative speed, a speed of the vehicle, and a yaw rate of the vehicle;
acquiring first-direction is an index indicating movement of the detection target object in the predetermined first direction (leftward direction in the circumferential direction around the object recognition sensor 21 or approaching direction in the line-of-sight direction of the object recognition sensor 21);
acquiring, based on the ground speed, second-direction reliability that is an index indicating movement of the detection target object in the second direction (rightward direction in the circumferential direction around the object recognition sensor 21 or separating direction in the line-of-sight direction of the object recognition sensor 21) that is a direction opposite to the first direction; and
determining whether the detection target object is a stationary object or a moving object based on the first-direction reliability and the second-direction reliability.

That is, for example, it is determined whether an object (detection target object) has moved in each of the clockwise and counterclockwise directions (rightward and leftward directions) in a circumferential direction, and the reliability is added or subtracted in each of the clockwise and counterclockwise directions (rightward and leftward directions). Then, it is determined whether the object (detection target object) is a moving object (including a moving direction) or a stationary object using the result of the added/subtracted reliability.

According to the present embodiment, for example, even in a situation where an object is determined as a moving object that reciprocates left and right due to an angle error, the object can be determined as a stationary object.

In other words, by determining whether the detection target object is a stationary object or a moving object by using the reliability decomposed in the moving direction (for example, in accordance the reliability separately provided in the leftward direction and the rightward direction) in a situation where an angle error large enough to make the stationary object appear to be moving occurs, it is possible to prevent erroneous determination as a crossing object.

Note that the present invention is not limited to the above-described embodiments, and includes various modifications. For example, the above-described embodiments have been described in detail for easy understanding of the present invention, and the present invention is not necessarily limited to those having all the described configurations.

In addition, some or all of the above-described components, functions, processing units, processing means, and the like may be realized by hardware, for example, by designing with an integrated circuit. In addition, each of the above-described components, functions, and the like may be realized by software by a processor interpreting and executing a program for realizing each function. Information such as a program, a table, and a file for realizing each function can be stored in a recording device such as a memory, a hard disk, and an SSD (Solid State Drive), or a recording medium such as an IC card, an SD card, and a DVD.

### REFERENCE SIGNS LIST

1 vehicle (host vehicle)
10 vehicle control device (object detection device)
11 parameter storage unit
12 object ground speed calculation unit (ground speed acquisition unit)
13 line-of-sight direction movement determination unit (determination unit in the second embodiment)
14 circumferential direction movement determination unit (determination unit in the first embodiment)
15 alarm unit
21 object recognition sensor
21a radar
21b monocular camera
22 vehicle speed sensor
23 steering angle sensor
24 yaw rate sensor
31 alarm device
2 object
2a moving object (pedestrian or the like)
2b stationary object (electric poles, signs, or the like)
2c stationary object (wall or the like)
V_{IA} object ground speed
V_{rad} line-of-sight direction component of object ground speed
V_{cir} circumferential direction component of object ground speed

1. An object detection device comprising:
a ground speed acquisition unit that
acquires a relative position and a relative speed between a detection target object around a vehicle and the vehicle, the relative position and the relative speed being detected by an object recognition sensor mounted on the vehicle, and
acquires a ground speed of the detection target object based on the relative position, the relative speed, a speed of the vehicle, and a yaw rate of the vehicle; and
a determination unit that
acquires, based on the ground speed, first-direction reliability that is an index indicating movement of the detection target object with respect to a predetermined first direction,
acquires, based on the ground speed, second-direction reliability that is an index indicating movement of the detection target object with respect to a second direction that is a direction opposite to the first direction, and
determines whether the detection target object is a stationary object or a moving object based on the first-direction reliability and the second-direction reliability.

2. The object detection device according to claim 1, wherein the first direction is a leftward direction in a circumferential direction around the object recognition sensor, and the second direction is a rightward direction in the circumferential direction around the object recognition sensor.

3. The object detection device according to claim 2, wherein the object recognition sensor is a radar.

4. The object detection device according to claim 1, wherein the first direction is an approaching direction in a line-of-sight direction of the object recognition sensor, and the second direction is a separating direction in the line-of-sight direction of the object recognition sensor.

5. The object detection device according to claim 4, wherein the object recognition sensor is a monocular camera.

6. The object detection device according to claim 1, wherein the determination unit determines whether the detection target object is a stationary object or a moving object when the speed of the vehicle is a predetermined value or less.

7. The object detection device according to claim 6, wherein the determination unit determines whether the detection target object is a stationary object or a moving object when the vehicle is stopped.

8. The object detection device according to claim 1, wherein the determination unit determines the detection target object as a stationary object when both the first-direction reliability and the second-direction reliability are less than a predetermined threshold value.

9. The object detection device according to claim 1, wherein the determination unit determines the detection target object as a stationary object when both the first-direction reliability and the second-direction reliability are a predetermined threshold value or more.

10. The object detection device according to claim 1, wherein the determination unit determines the detection target object as a moving object when the first-direction reliability is a predetermined threshold value or more and the second-direction reliability is less than the threshold value, or when the first-direction reliability is less than the threshold value and the second-direction reliability is the threshold value or more.

11. The object detection device according to claim 10, wherein the determination unit determines that a moving direction of the moving object is the first direction when the first-direction reliability is the predetermined threshold value or more and the second-direction reliability is less than the threshold value, and determines that the moving direction of the moving object is the second direction when the first-direction reliability is less than the threshold value and the second-direction reliability is the threshold value or more.

12. An object detection method executed by a control unit mounted on a vehicle, the object detection method comprising:
by the control unit,
acquiring a relative position and a relative speed between a detection target object around a vehicle and the vehicle, the relative position and the relative speed being detected by an object recognition sensor mounted on the vehicle;
acquiring a ground speed of the detection target object based on the relative position, the relative speed, a speed of the vehicle, and a yaw rate of the vehicle;
acquiring, based on the ground speed, first-direction reliability that is an index indicating movement of the detection target object with respect to a predetermined first direction;
acquiring, based on the ground speed, second-direction reliability that is an index indicating movement of the detection target object with respect to a second direction that is a direction opposite to the first direction; and
determining whether the detection target object is a stationary object or a moving object based on the first-direction reliability and the second-direction reliability.
